(19) United States
(12) Patent Application Publication
(10) Pub. No.: US 2012/0256513 A1
(43) Pub. Date: Oct. 11, 2012

(54) STATOR FOR AN ELECTRIC MOTOR AND METHOD FOR THE PRODUCTION THEREOF

(75) Inventors: BERNHARD KESSLER, BURKARDROTH (DE); CHRISTIAN FINGER, BAD KISSINGEN (DE)

(73) Assignee: BROSE FAHRZEUGTEILE GMBH & CO KG, WURZBURG, WURZBURG (DE)

(21) Appl. No.: 13/487,749

(22) Filed: Jun. 4, 2012

Related U.S. Application Data
(63) Continuation of application No. PCT/EP2010/005584, filed on Sep. 11, 2010.

(30) Foreign Application Priority Data
Dec. 2, 2009 (DE) 102009056647.3

(51) Int. Cl. H02K 1/14; H02K 15/02

(52) U.S. Cl. 310/216.016; 29/596

(57) ABSTRACT

A stator for a motor contains a number of stator sheets stacked in a star-shaped laminated core. The stator sheets contain stator sheets closed in the circumferential direction and have single teeth connected to one another by pole shoe webs and stator sheets open in the circumferential direction and have single teeth spaced apart from one another to form a gap. A bottom starting block is adjoined by a repeat block which has N identical repeat sequences. Each repeat sequence contains n directly consecutive open stator sheets with a gap on the pole shoe side and at least one closed stator sheet. The laminated core also has a terminating block and an intermediate block between the repeat block and the terminating block. The intermediate block contains a closed stator sheet and/or a gap on the pole shoe side created by m open stator sheets, where 1≦m≦n−1.

### CROSS-REFERENCE TO RELATED APPLICATION

This application is a continuation application, under 35 U.S.C. §120, of copending international application No. PCT/EP2010/005584, filed Sep. 11, 2010, which designated the United States; this application also claims the priority, under 35 U.S.C. §119, of German patent application No. DE 10 2009 056 647.3, filed Dec. 2, 2009; the prior applications are herewith incorporated by reference in their entirety.

### BACKGROUND OF THE INVENTION

### Field of the Invention

The invention relates to a stator for an electric motor, containing a number of stator sheets stacked in a star-shaped laminated core, which stator sheets contain stator sheets that are closed in the circumferential direction and have single teeth connected to one another by pole shoe webs and stator sheets that are open in the circumferential direction and have single teeth spaced apart from one another on the pole shoe side. It also relates to a method for producing such a stator in a star-shaped laminated core

An electric motor is an energy converter, which converts electrical energy into mechanical energy. Such an electric motor contains a stator, which forms the fixed part of the motor, and a rotor, which forms the moving part of the motor. In the case of an internal-rotor motor, the stator is usually provided with a stator yoke, arranged on which, radially toward the center, are inwardly projecting stator teeth, the free ends of which that are facing the rotor forming the so-called pole shoe. Attached to the stator teeth are windings, which generate a magnetic field during the electromotive operation. For conducting and strengthening the magnetic field generated by the windings to which current is applied, the stator material is usually metallic, for example of magnetically soft iron.

In the production of the stator, applying the winding around the stator teeth proves to be relatively difficult, because the stator yoke prevents access to the stator teeth from the outside. The pole shoes make it difficult to access the stator teeth for applying the winding from the inside. In order to avoid a complicated winding process, a multipart structure of the stator is therefore usual. For this purpose, first a laminated core is produced with star-shaped stator teeth, which on the pole shoe side are connected to one another by pole shoe webs, also referred to hereafter as leakage webs, in order to achieve a mechanically stable assembly. The stator is in this case produced from individual, stamped stator sheets, in that they are put together in a mechanically stable assembly to form the star-shaped sheet stack.

After providing the externally accessible stator teeth with the windings (coil windings), the laminated core is inserted into the stator yoke, forming a return ring, and is joined by pressing or shrinking. Disadvantageous here are the leakage webs required for mechanical stabilization, since they cause an undesired magnetic short-circuit.

Published, non-prosecuted German patent application DE 198 42 948 A1, corresponding to U.S. Pat. No. 6,483,221, discloses a method of producing a laminated core of a stator for an electric motor. The laminated core is built up in layers of at least two different sheet-metal laminations. For example, only every fifth sheet is intended to have leakage webs on the inside, the sheets of the laminated core lying between these sheets being formed without leakage webs, and therefore forming a gap on the pole shoe side. Such a laminated core can be provided with windings from the outside in one operation.

Such a configuration of the stator does allow a certain mechanical stability of the stator to be achieved, while at the same time the magnetic short-circuit via the leakage webs between the pole shoes is small. However, with this type of construction it is not possible for production reasons to avoid a varying thickness of the stator sheets on account of virtually unavoidable tolerances. Consequently, to accomplish a specific height of the laminated core, differing numbers of stator sheets are required from core to core. Furthermore, to maintain the mechanical stability, each laminated core has to terminate with at least one layer of closed stator sheets with leakage webs between the stator teeth.

Therefore, the practice up until now has been that first a certain number of stator sheets are stacked in a specific sequence of closed stator sheets with leakage webs and open stator sheets without leakage webs. Until the desired stack height is reached, then only closed stator sheets are stacked. Although this method ensures the necessary mechanical stability, the magnetic short-circuiting properties of the stator become worse with every closed terminating sheet.

### SUMMARY OF THE INVENTION

The invention is based on the object of providing a stator for an electric motor of which the star-shaped laminated core is as optimum as possible in terms of both mechanical stability and magnetic short-circuiting properties. It is intended always to reach, and in particular not to exceed, a specified sheet stack height irrespective of tolerances of the sheet thickness of individual stator sheets. It is also intended to provide a particularly suitable stacking method for producing the stator.

For this purpose, the stator has in its laminated core a starting block, at the bottom in the stacking direction, containing precisely two closed stator sheets. A single sheet of the starting block, conceivable in principle, would be desirable in terms of the magnetic short-circuiting properties, but, as can be appreciated, would not be able to ensure the required mechanical stability within the laminated core as a whole.

The starting block is ajoined within the laminated core of the stator by a repeat block, which has open stator sheets and closed stator sheets in a number of identical repeat sequences. In this case, each repeat sequence contains—in the longitudinal direction of the stack—directly consecutive open stator sheets with a gap on the pole shoe side between the stator teeth and at least one closed stator sheet. As can be appreciated, with adequate mechanical stability only a single closed stator sheet is provided in each repeat sequence of the repeat block, for a magnetic short-circuit that is as small as possible.

To optimize the mechanical stability on the one hand and the magnetic short-circuiting properties within the repeat block—and consequently within the laminated core as a whole—on the other hand, precisely two directly consecutive open stator sheets are provided in each repeat sequence of the repeat block.

The laminated core of the stator also has a terminating block containing at least one closed stator sheet. In terms of adequate mechanical stability, the laminated core preferably terminates with at least two and at most three closed stator sheets.

To reach the specific or required height of the laminated core, an intermediate block is provided between the repeat block and the terminating block. Depending on the specified height of the laminated core, this intermediate block may have no stator sheet, if the terminating block already consists of two closed stator sheets. Alternatively, if the terminating block consists of only one closed stator sheet, the intermediate block has precisely just one closed stator sheet. According to a further alternative, two closed stator sheets are provided in the intermediate block, separated by at least one open stator sheet. This produces a first variant of the stator in which no stator sheet is provided in the intermediate block if the terminating block already has two closed stator sheets. According to a second variant, the intermediate block then has one closed stator sheet and/or at least one open stator sheet with a gap on the pole shoe side.

The intermediate block consequently allows particularly flexible compensation for the tolerances of the sheet thicknesses of the individual layers of sheets, containing open and/or closed stator sheets, that add up in the laminated core. This ensures that the specified height of the laminated core is reached comparatively exactly, and in particular is not exceeded. This in turn ensures that the coil windings, which are usually produced on separate winding mandrels, can always be fitted with the same internal diameter onto the stator teeth of the laminated core, with as little oversize as possible and reliably avoiding undersize, which would make it virtually impossible for this coil winding to be fitted onto the individual stator teeth without it being destroyed.

To stack the open and closed stator sheets to form the star-shaped laminated core of a predetermined height of the core, consequently first a starting block, at the bottom in the stacking direction, is formed by two closed stator sheets. This starting block is adjoined by a repeat block containing open and closed stator sheets in a number of identical repeat sequences. These repeat sequences are in this case formed by a gap with directly consecutive open stator sheets and at least one closed stator sheet.

Depending on the height of the laminated core already reached with the starting block and the repeat block, either a terminating block is placed directly onto the repeat block, if the terminal block is formed by two stator sheets. If it is only formed by one closed stator sheet, first an intermediate block with a closed stator sheet and with a gap created by open stator sheets is formed on the repeat block, the number of the open stator sheets being ultimately dependent on the number of open stator sheets forming the gaps in the repeat block. The gap consists in this case of at least one open stator sheet and a maximum number of open stator sheets, which number is less by one open stator sheet than the number of open stator sheets within the gaps of the repeat sequences of the repeat block.

To complete the stator, the star-shaped laminated core is inserted into a cylindrical stator yoke, which is pressed or joined in a form-fitting and/or force-fitting manner with the laminated core, in particular in a pulsed joining process. During the production of the star-shaped laminated core, the stator sheets are suitably stamped layer by layer. This has the effect of avoiding in an easy and reliable way any radial and axial displaceability of the individual stator sheets with respect to one another, and consequently any deformation and lack of uniformity of the laminated core assembly.

Other features which are considered as characteristic for the invention are set forth in the appended claims.

Although the invention is illustrated and described herein as embodied in a stator for an electric motor and method for the production thereof, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a star-shaped laminated core of a stator with open and closed stator sheets stacked one on top of the other according to the invention;

FIG. 2 is a perspective view of a detail of the star-shaped laminated core according to FIG. 1 with the open and closed stator sheets stacked one on top of the other;

FIG. 3 is a plan view of an individual closed stator sheet with pole shoe webs;

FIG. 4 is a plan view of an individual open stator sheet with gaps on the pole shoe side;

FIG. 5 is a diagrammatic, sectional view in a form of a detail of the laminated core with a starting block, a repeat block, a terminating block and an intermediate block, with an open stator sheet between the repeat block and the terminating block;

FIG. 6 is sectional view in a form of a detail of the laminated core with the starting block, the repeat block, the terminating block and the intermediate block, with two open stator sheets between the repeat block and the terminating block;

FIG. 7 is a sectional view in a form of a detail of the laminated core with the starting block, the repeat block, the terminating block and the intermediate block, with no stator sheet or with two open stator sheets and one closed stator sheet between the repeat block and the terminating block; and

FIG. 8 is a perspective view of the stator of an electric motor with the laminated core inserted into an annular stator yoke.

### DETAILED DESCRIPTION OF THE INVENTION

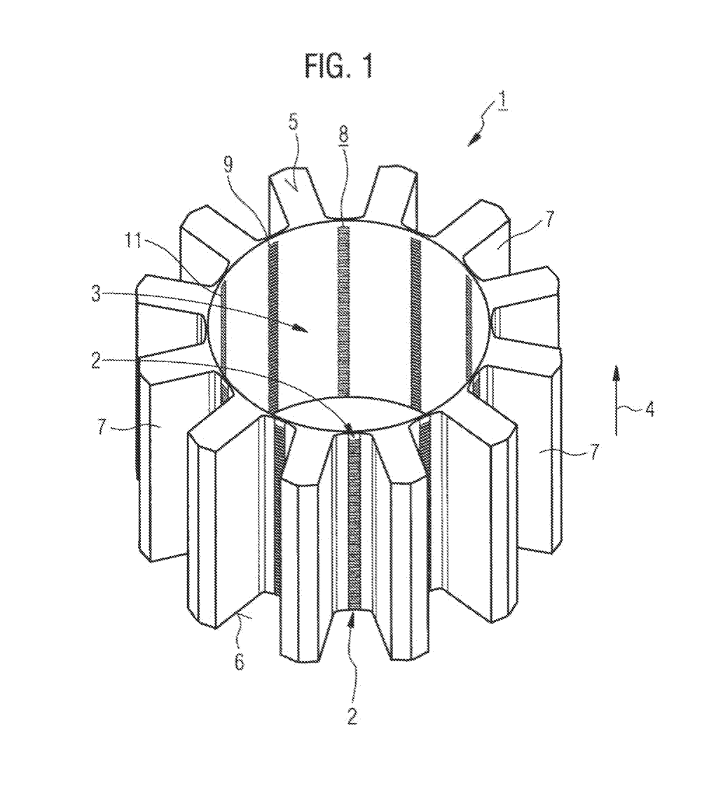

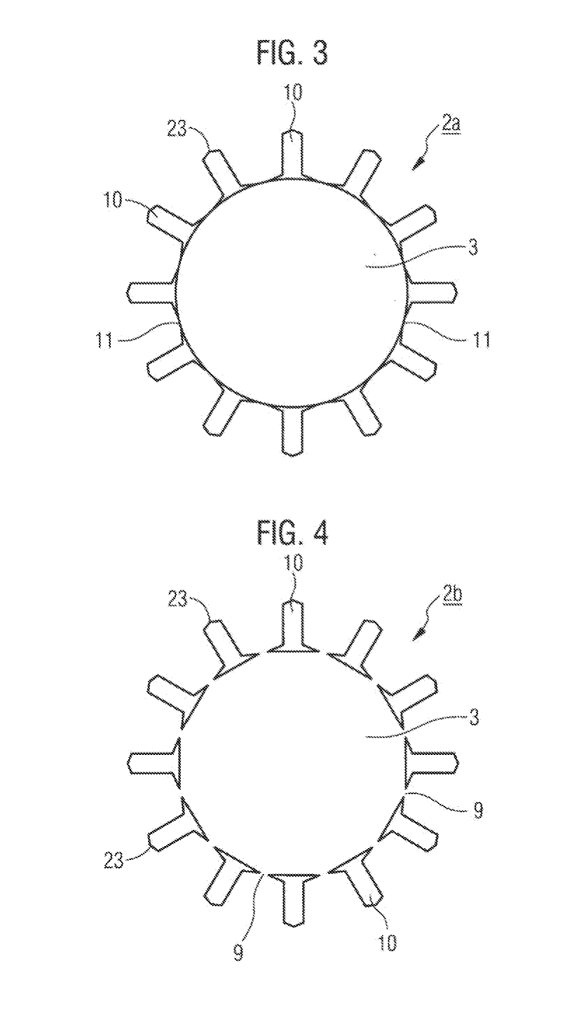

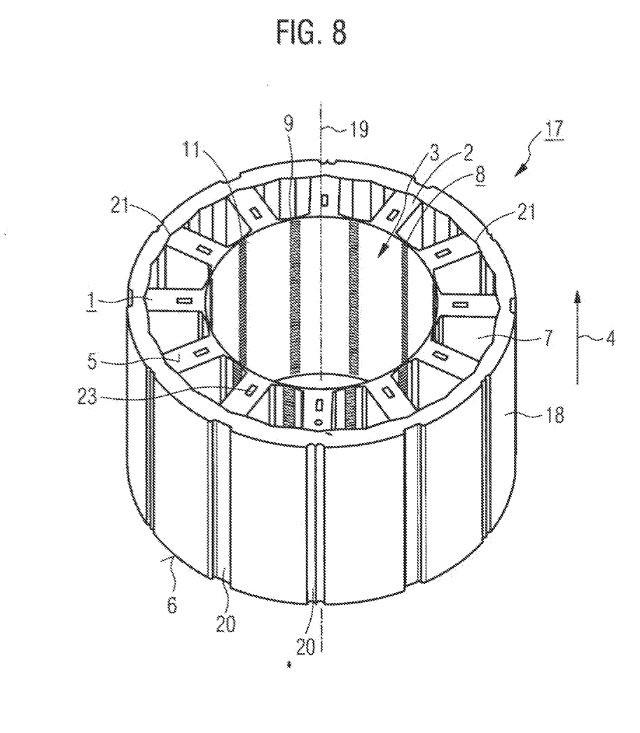

Parts that correspond to one another are provided with the same designations in all the figures. Referring now to the figures of the drawing in detail and first, particularly, to FIG. 1 thereof, there is shown a star-shaped laminated core 1 containing stator sheets 2 stacked in layers one on top of the other, in the assembled state. The stator sheets 2 are stacked one on top of the other in a stacking direction 4, forming a central, cylindrical opening 3, and are for example stamped with one another. The laminated core 1 is part of a stator (FIG. 8) of an electric motor, which is not represented any more specifically. The laminated core 1 terminates on its upper side 5 and underside 6 respectively with at least one stator sheet 2a that is closed in the circumferential direction, such as the one shown in FIG. 3.

The laminated core 1 contains radially extending stator teeth 7, which form on the inside, situated radially towards the middle, a cylindrical pole shoe 8. The pole shoe 8, which is facing a non-illustrated rotor of the electric motor, is only partially circumferentially closed in the stacking direction 4, forming gaps 9 on the pole shoe side, in order to reduce a magnetic short-circuit.

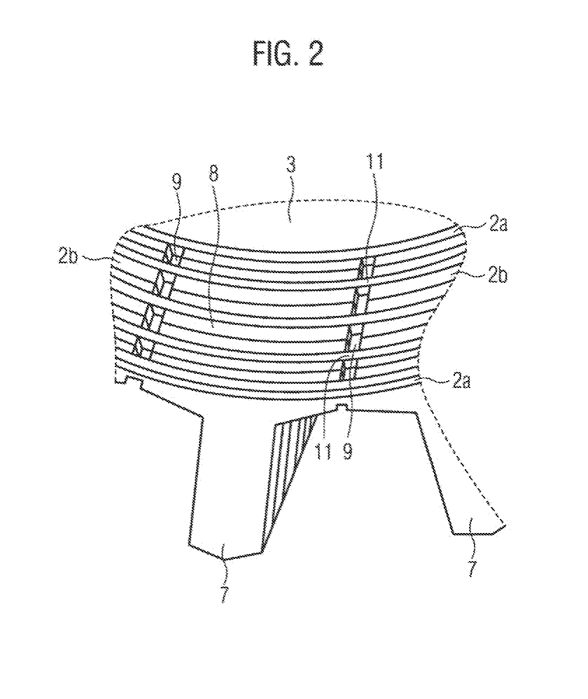

FIG. 2 shows a detail of the star-shaped laminated core 1 represented in FIG. 1, with a view of the inner pole shoe 8 of the laminated core 1. It can be seen comparatively clearly here that the gaps 9 are formed by open stator sheets 2b, such as the one shown in FIG. 4. The open stator sheets 2b consist virtually only of single teeth or single tooth sheets 10.

The gaps 9 on the pole shoe side are delimited on the inside of the laminated core 1 in the stacking direction 4 by pole shoe webs 11, in order to fix the open stator sheets 2b that are adjacent in the stacking direction 4 in their intended position in the stacked assembly of the laminated core 1, and thereby ensure the required mechanical stability of the laminated core 1. The pole shoe webs 11 respectively connect two adjacent single teeth 10 of the stator sheet 2a that is closed in the circumferential direction to one another.

The single teeth 10 of the closed stator sheets 2a and of the open stator sheets 2b are arranged in the laminated core 1 in such a way that all of the single teeth 10 terminate with their outer contour lying one above the other, and thereby form the uniform and consistently formed stator teeth 7. Non-illustrated coil windings are applied to the radially outwardly facing stator teeth 7. The coil windings are usually wound on a separate winding mandrel, and are consequently always the same in terms of their clear width, corresponding to the outside diameter of the winding mandrel. In electromotive operation, current is applied to these coil windings and they generate a magnetic field. The magnetic field is strengthened and conducted by the sheet stack 1, consisting of magnetically soft iron.

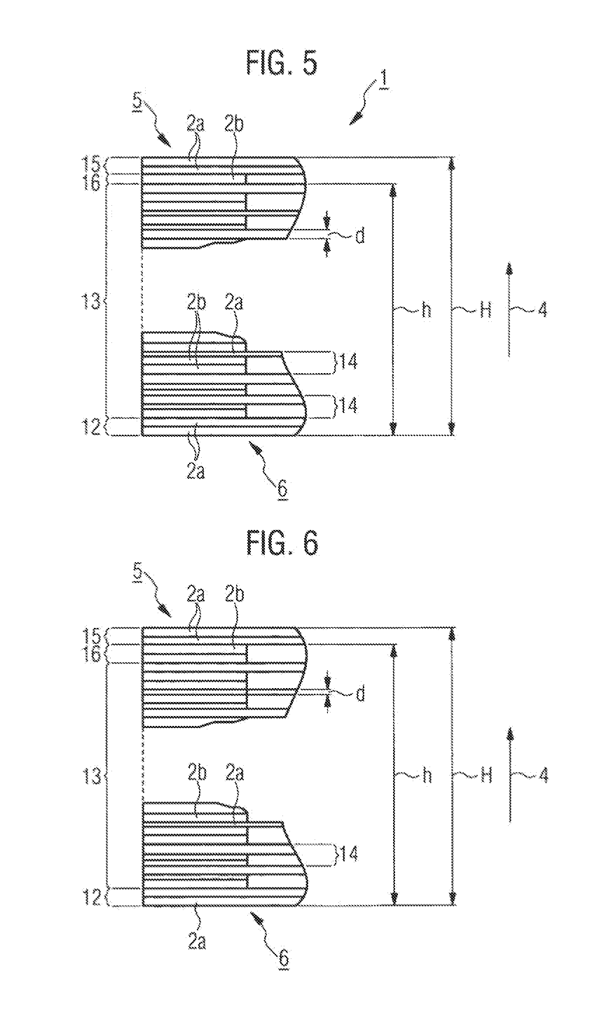

FIG. 5 shows in a sectional representation in the form of a detail of the laminated core 1, which is provided on its underside 6 with two closed stator sheets 2a lying directly one on top of the other in the stacking direction 4. The two lowermost closed stator sheets 2a form a starting block 12 of the laminated core 1. The starting block 12 serves for mechanically stabilizing the laminated core 1.

The starting block 12 is adjoined in the stacking direction 4 by a repeat block 13 with n repeat sequences 14. Each repeat sequence 14 consists, in the stacking direction 4, of two open stator sheets 2B and one individual closed stator sheet 2a. The alternating sequence of two open stator sheets 2b and one closed stator sheet 2a has the effect of achieving an optimum in respect of the almost contradicting requirements of highest possible mechanical stability and smallest possible magnetic short-circuit of the laminated core 1.

The laminated core 1 is terminated on its upper side 5 by a terminating block 15 containing two closed stator sheets 2a. On account of the production tolerances, the sheet thickness d of individual stator sheets 2b, 2a deviates from one to the other, the deviations or the tolerances adding up within the laminated core 1. This inevitably results in deviations of the height of the laminated core in the stacking direction 4.

In order nevertheless always to ensure a specific, specified height of the laminated stack or total stack height H in the production of the laminated core 1, and in particular in the production of a large number of such laminated cores 1, i.e. in particular not to exceed the height, an intermediate block 16 is provided between the repeat block 13 and the terminating block 15. The number of layers of stator sheets 2b, 2a of the intermediate block 16 is based on the sheet stack height h that is reached after a specified number of repeat sequences 14. The sheet stack height h varies from core 1 to core 1 and is dependent on the sheet thicknesses d of the stacked open stator sheets 2b and closed stator sheets 2a.

To reach the specified total sheet stack height H, an intermediate block 16 with a greater or lesser number of open and/or closed stator sheets 2b and 2a is inserted, depending on the difference between the total sheet stack height H and the sheet stack height h reached with the starting block 12 and the repeat block 13.

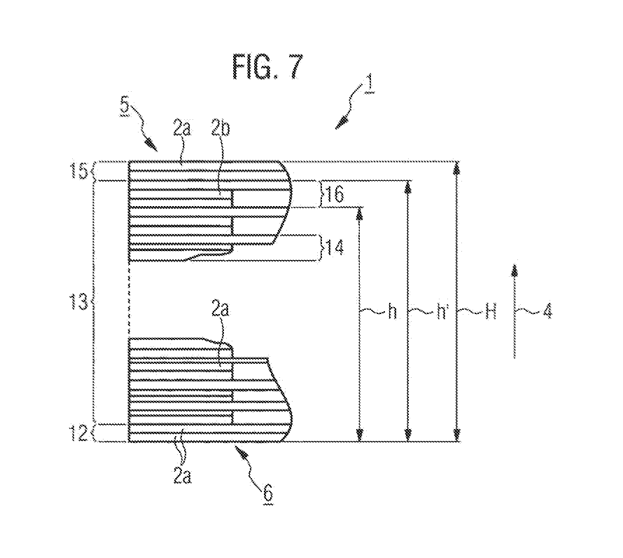

According to FIG. 5, the intermediate block 16 may be formed by an open stator sheet 2b. FIG. 6 shows a laminated core 1, the intermediate block 16 of which contains two open stator sheets 2b. FIG. 7 shows a laminated core 1 of which the intermediate block 16 contains two open stator sheets 2b and one closed stator sheet 2a. This corresponds in the exemplary embodiment to the repeat sequence 14. If no specific number n of the repeat sequences 14 until the sheet stack height h is reached is specified, this specific embodiment could also be considered with an intermediate block 16 that does not comprise a stator sheet 2. Otherwise, that is to say if a specific number n of the repeat sequences 14 until the sheet stack height h is reached is specified, the intermediate block 16 consists of the two open stator sheets 2b and the one closed stator sheet 2a. The intermediate block 16 may be formed by no stator sheet, one or more open stator sheets 2b and/or closed stator sheets 2a. The intermediate block 16 consequently provides a particularly simple means of allowing the mechanical stability and short-circuiting properties of the laminated core 1 to be optimized.

FIG. 8 shows a stator 17, which is obtained by joining the star-shaped laminated core 1 and a stator yoke 18. The stator yoke 18 is suitably a cylindrical shell of solid material. However, the stator yoke may also be produced from return ring sheets stacked one on top of the other. In the assembled state, the windings, which here once again cannot be seen, are placed around the stator teeth 7 of the laminated core 1. The windings are placed onto the stator teeth 7 before the joining of the laminated core 1 and the stator yoke 18. In electromotive operation, the windings provided with current generate the stator-side magnetic field, which interacts with permanent magnets of the rotor of the brushless electric motor that rotates about the central stator or motor axis 19.

Along the outer circumference, the stator yoke 18 is provided with stamping or joining slots 20. The stamping or joining slots 20 extend along the stacking direction 4 and serve for the pressing of the stator yoke 18 with the laminated core 1 by the so-called pulsed joining method. During the pressing or joining method, wedge-shaped tooth tips 21 of the single teeth 7 lying radially opposite the pole shoe 8 penetrate into the stator material in a form-fitting manner. On the upper side 5 of the laminated core 1, stamped impressions 22 can be seen in the single tooth sheet portions of the uppermost closed stator sheet 2a.

1. A stator for an electric motor, the stator comprising:
a star-shaped laminated core formed from a number of stacked stator sheets, some of said stator sheets being closed stator sheets being closed in a circumferential direction and having pole shoe webs and single teeth connected to one another by means of said pole shoe webs, others of said stator sheets being open stator sheets being open in the circumferential direction and having single teeth spaced apart from one another to form a gap on a pole shoe side, a starting block, at a bottom in a stacking direction, being formed by at least one of said closed stator sheets, said starting block being adjoined by a repeat block having said open stator sheets and said closed stator sheets in N identical repeat sequences, each of the identical repeat sequences containing n directly consecutive said open stator sheets and at least one said closed stator sheet, said star-shaped laminated core further having a terminating block containing at least one said closed stator sheet and an intermediate block disposed between said repeat block and said terminating block, said intermediate block, depending on a specified total sheet stack height, containing at least one of none of said stator sheets, one of said closed stator sheets or m of said open stator sheets, where 1≦m≦n−1.

2. The stator according to claim 1, wherein said starting block has two of said closed stator sheets.

3. The stator according to claim 1, wherein only a single said closed stator sheet is provided in each of said identical repeat sequences of said repeat block.

4. The stator according to claim 1, wherein two directly consecutive said open stator sheets are provided in each of said identical repeat sequences of said repeat block.

5. The stator according to claim 1, wherein said intermediate block contains one of said closed stator sheets and a single of said open stator sheets.

6. The stator according to claim 1, wherein said intermediate block has only a single of said open stator sheets.

7. The stator according to claim 1, wherein said terminating block has two of said closed stator sheets.

8. The stator according to claim 1, further comprising a cylindrical stator yoke and said star-shaped laminated core is inserted into said cylindrical stator yoke.

9. A method for producing a stator, which comprises the steps of:
stacking a number of stator sheets for forming a star-shaped laminated core, the stator sheets including closed stator sheets being closed in a circumferential direction and have single teeth connected to one another by means of pole shoe webs and open stator sheets being open in the circumferential direction and have single teeth spaced apart from one another on a pole shoe side, the stacking step including the further steps of:
forming a starting block, at a bottom in a stacking direction, formed by two of the closed stator sheets;
subsequently forming a repeat block containing N identical repeat sequences each formed by n directly consecutive ones of the open stator sheets and at least one of the closed stator sheets, wherein, depending on a total sheet stack height reached, at least one of no intermediate block, an intermediate block with the closed stator sheet, or m of the open stator sheets, where 1≦m≦n−1, being formed on the repeat block; and
forming a terminating block from at least one of the closed stator sheets on one of the identical repeat blocks or the intermediate block.

10. The method according to claim 9, which further comprises inserting the star-shaped laminated core into a cylindrical stator yoke and the cylindrical stator yoke is pressed with the star-shaped laminated core in a joining operation.

11. The method according to claim 10, which further comprises performing a pulsed joining process as the joining operation.
